(19) United States
(12) Patent Application Publication
(10) Pub. No.: US 2005/0087109 A1
(43) Pub. Date: Apr. 28, 2005

(54) Container for protecting an object against theft

(75) Inventor: Othmar Bruhwiler, Zuzwil (CH)

Correspondence Address: MORGAN LEWIS & BOCKIUS LLP, 1111 PENNSYLVANIA AVENUE NW, WASHINGTON, DC, 20004, US

(73) Assignee: Pataco AG, Industrie-und Unterhaltungselektronik

(21) Appl. No.: 10/886,048

(22) Filed: Jul. 8, 2004

(30) Foreign Application Priority Data
Jul. 8, 2003 (CH) 1191/03

(51) Int. Cl. E05G 1/04

(52) U.S. Cl. 109/59 R

(57) ABSTRACT

The lockable container (10) with two shell-like parts (20, 30) for protecting an object against theft is provided with a [locking mechanism?], which comprises a bolt (50) that can move between an unlocked position and a locked position, as well as contours (27, 37, 38) in both parts, which protect the bolt from dropping out in one of the two parts (30) when the container is open and interact with the bolt in the locked position when the container is closed and prevent an opening of the container. The bolt is secured in the locked position against moving into the open position by a securement (60), which can be released from the outside only with the help of a special tool. According to the invention, the contours in both parts comprise very shape-stable eyelets (27, 37), which when the container is closed are at least pairwise bearing against each other and mutually overlapping, and in which the bolt engages in the locked position. Opening forces acting on the container are thereby transferred by the bolt in its locked position along the shortest possible path without long lever arms from one part to the other, while the bolt as a whole remains free of forces.

### TECHNICAL FIELD

The present invention concerns a lockable container with two shell-like parts for protecting an object against theft, wherein the locking mechanism of the container comprises a bolt which can be moved between an unlocked position and a locked position, as well as contours in both parts, which protect the bolt from dropping out in one of the two parts when the container is open and interact with the bolt in the locked position when the container is closed and prevent an opening of the container, the bolt in the locked position being protected against shifting into the open position, and this protecting can only be released from the outside with the help of a special tool.

Such containers, also known as “safes,” are used in shops that are outfitted with an electronic theft protection system, wherein the circuits detected by the protection system and triggering an alarm during an attempted theft, e.g., in the form of so-called “tags,” are arranged together with the object being protected on the inside of the container and are thus inaccessible to the customer. When the customer pays for the item, it is taken out of the container by the sales personnel, making use of a special tool available only to them, and it can then be taken out of the store by the customer without triggering an alarm. The container remains in the store and can be filled with a new item and be placed back on display.

In order for the objects on sale to be visible in the containers, they generally consist of a transparent plastic material. One also wishes the containers to be as filigreed as possible and as inconspicuous as possible compared to the objects being sold. On the other hand, however, there is the requirement that the containers must be sufficiently stable in order to fulfill their task of theft protection. They should be at least so stable that they cannot be broken into unnoticed in a retail store, even by using a tool.

In this regard, as with all protection systems, there is a constant competition between the thief, on the one hand, to overcome the protection system with ever more novel means, and the manufacturer of the protection system on the other hand, to improve it in response to the former, so that the requirements for security and stability of the containers are constantly increasing.

As an accessory ultimately increasing the costs of the actual products, the containers should be as favorable as possible.

### STATE OF THE ART

A protection container of the above-mentioned kind is known, for example, from EP 0 616 103 B1. In the familiar container, a shell-like cover part is hinged to a likewise shell-like bottom part by means of hinges. In a narrow compartment between the front side wall of the bottom part and a partition wall, a movable bolt is accommodated in the bottom part, which in its locking position when the container is closed engages with projecting dogs projecting contours on the cover part. The contours which themselves retain the slide in the bottom part on the other side are not shown in EP 0 616 103 B1. In a commercially available product somewhat corresponding to EP 0 616 103 B1, these are cams on the partition wall, engaging in lengthwise holes of the slide.

It turns out that this known configuration no longer totally meets the increased requirements on security. Weaknesses are primarily the contours contributing to the locking mechanism on the parts which can be broken off in use by sufficiently large forces.

Of course, an obvious measure would be to simply make these structures stronger. However, this conflicts with the above-mentioned requirement that the container should be as filigreed as possible on the whole. Bulky locking mechanisms are a great hindrance in this respect.

### PRESENTATION OF THE INVENTION

The problem of the invention is therefore to indicate a container of the kind mentioned above, which is more safe and stable to unauthorized opening, yet at the same time not less filigreed in configuration and finally at least not more costly and expensive in its manufacture.

This problem is solved according to the invention by a container, as is characterized in Patent Claim 1. The essence of the invention consists in that the contours in both parts each comprise eyelets, which when the container is closed are at least pairwise bearing against each other and mutually overlapping, and which engage the bolt in the locking position.

Eyelets, even in small configuration, are very shape-stable, because unlike a hook they have no free end and can be anchored at two points at least, on either side of a zone loaded by the bolt. The rear eyelet in the direction of engagement of the bolt could even be closed at one side, which further increases its stability.

Thanks to arranging the eyelets at least bearing against each other in pairs and also mutually overlapping each other, the opening forces acting on the container from the bolt in its locking position are transferred from one part to the other on the shortest possible path without long lever arms. The bolt as a whole remains for the most part free of forces. The contours protecting the bolt from dropping out when the container is open can likewise be configured very small and quite weak as a result. Instead of only two eyelets interacting in pairs, one could also provide groups of three or even more eyelets, in which case one eyelet on one of the two shell-like parts engages between two slightly spaced eyelets on the other shell-like part.

The features characterized in the subsidiary claims serve either to further increase the security of the container against unauthorized opening or at least have favorable influence on the handling of the container.

### BRIEF EXPLANATION OF THE FIGURES

The invention shall now be explained more closely by means of sample embodiments in connection with the drawing. This shows:

FIG. 1, in a perspective view, a theft protection container according to the invention, in opened up condition;

FIG. 2, a section (A-A) through the container of FIG. 1, with two enlarged detail views D and E; and

FIG. 3, a) in perspective view, the locking bolt of the container of FIG. 1, and b) a metal part of the locking bolt, seen from above.

### WAYS OF EMBODYING THE INVENTION

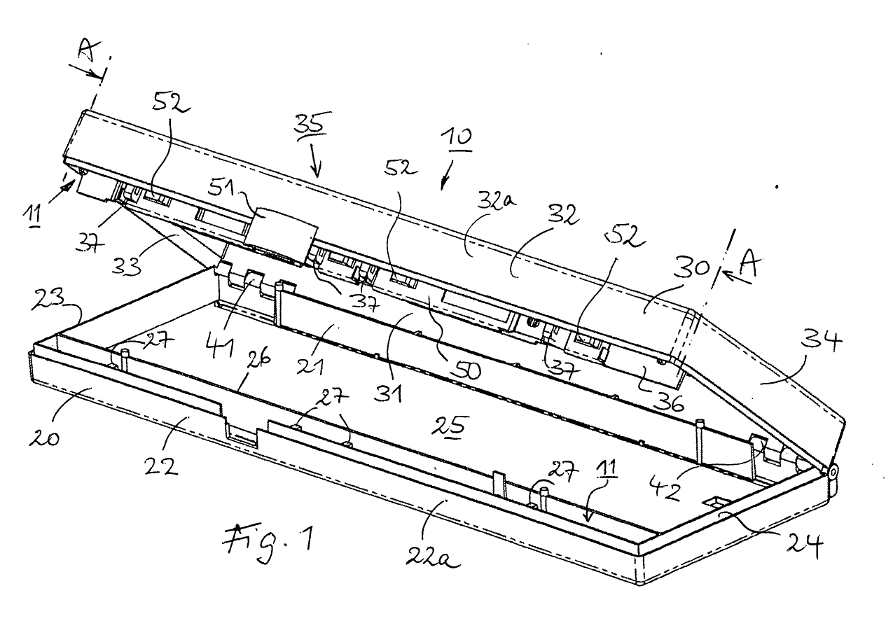

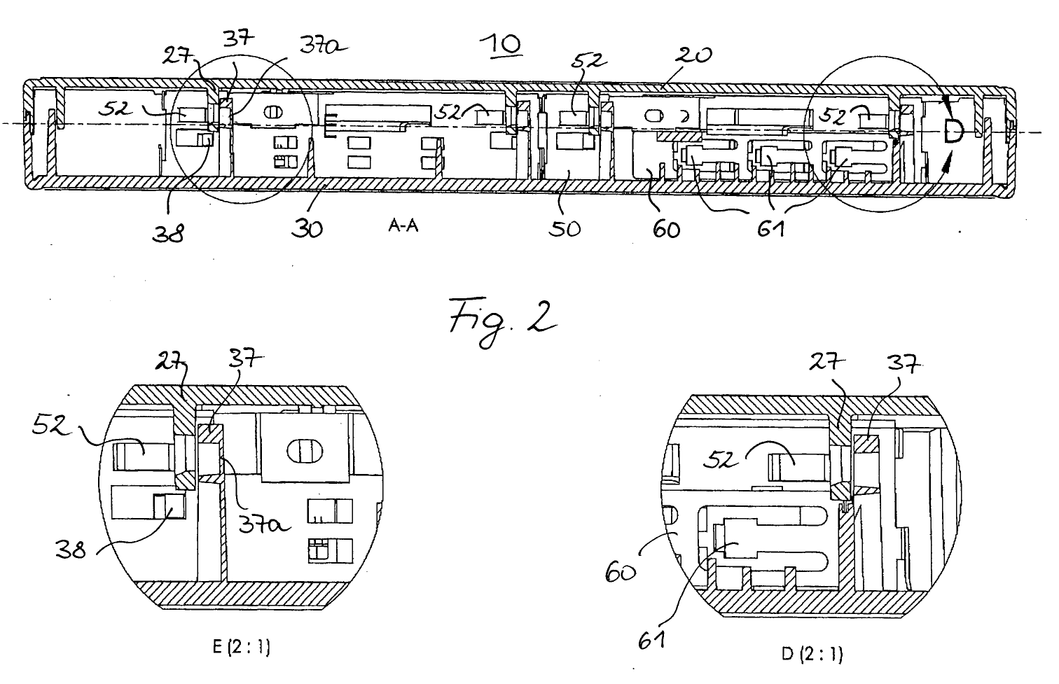

The container 10 of FIG. 1 and 2 serves to protect an object, which can essentially be of any given type, and which is not depicted in the figures. The object being protected, possibly including its packaging, must naturally be able to fit in the container 10. Preferably, the container is adapted in its size and shape to the object being protected, so it is not very much more bulky than it. Also not shown in the figures is a tag or the like, of an electronic protection system, with which the container must likewise be provided, in order to trigger an alarm during an attempted theft at the exit from a store outfitted with such a protection system. Such a tag can be arranged anywhere inside the container and can be affixed inside the container like an adhesive label, for example.

The container 10 has a shell-like bottom part 20 and a likewise shell-like cover part 30, which are movably linked together by two links 41 and 42, each in the region of its rear side walls 21 and 31.

The side walls 21-24 of the bottom part 20 are double-wall, except for cutouts in the region of the links 41 and 42, so that the side walls 31-34 of the cover part can engage between them when the container is closed and in this way the side walls mutually overlap.

In the cover part 30, a partition wall 36 is provided at a certain spacing from the front side wall 32, so that when the container 10 is closed this partition bounds off a narrow compartment 11 in it. When the container 10 is closed, the partition 36 overlaps with a corresponding partition 26 of the bottom part 20, which is likewise arranged at a certain spacing from the front side wall 22 of the bottom part and thereby contributes to form the compartment 11.

The locking mechanism of the container is arranged in the compartment 11, as shall now be described.

As functional parts of the locking mechanism of the container, eyelets 27 and 37 are configured in the compartment 11 both in the bottom part 20 and also in the cover part 30, each time in connection with the front side wall 22a or 32a, as well as the bottom plate 25 and the cover plate 35.

The eyelets 27 of the bottom part 20 are arranged slightly offset from the eyelets 37 of the cover part 30 in the axial direction of the links 41 and 42 and are configured such in their height that when the container is closed they overlap each other in pairs alongside each other. In this condition, their openings are aligned at least in pairs in the aforementioned axial direction, as can be recognized in FIG. 2.

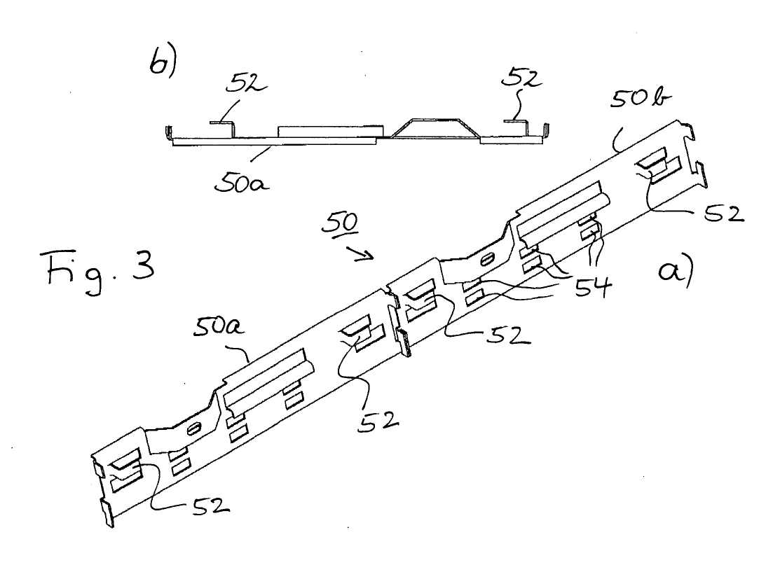

In the compartment 11, a bolt 50 is arranged as another functional part of the locking mechanism, being shown separately in FIG. 3, a). The bolt 50 is made of two identical metal parts 50a and 50b, hooked together at the end, having been made from a sheet metal material by stamping and/or embossing. FIG. 3 b) shows metal part 50a in top view.

The bolt 50 can move in the compartment 11 between an open position and a locked position by sliding lengthwise in the aforementioned axial direction. The figures show the bolt 50 in its open position.

In order to move the bolt 50, an activation button 51 is provided on it, which protrudes from the container through a lengthwise slot in the front side wall 22 of the bottom part.

Tongues 52 are punched out from the bolt 50, being at first bent out sideways from their plane and then bent over in their lengthwise direction. With these tongues 52, the bolt 50 engages with a pair of aligned eyelets 27 and 37 on the cover and on the bottom part when the container is closed in its locking position. In this way, the container 10 is bolted against opening. When the bolt is moved into its open position, the tongues 52 are retracted from the eyelets 27 and 37, whereupon the container is unbolted and can be opened.

The rear eyelets in the engaging direction of the bolt 50 or its tongues 52, here, the eyelet 37 in the cover part, need not necessarily go straight through. It could be closed at one end, as is represented in the left part of FIG. 2 and in the detail drawing E of FIG. 2 and designated as 37a. This helps further increase its stability.

The bolt 50 is protected against dropping out from the compartment 11 when the container is open by small lugs, which are formed on the partition wall 36 and engage in lengthwise slots 53 of the bolt 50. One of these lugs is designated as 38 in FIG. 2. Since the tongues 52 in the locking position engage with practically no play in the pairs of eyelets 27, 37 situated against each other, the retaining lugs 38 also remain unloaded when great force is exerted for unauthorized opening of the container.

For this reason, the protection of the bolt 50 also remains unloaded in its locking position. This protection is configured here like that already specified in EP 0 616 103 B1. It is formed by a metal band 60, arranged fixed in the compartment 11, with three resilient tongues 61. The metal band 60 can be recognized in FIGS. 2 and 3. In the locking position, these resilient tongues engage with mating hooks in a group of six recesses 54 of the bolt 50 and thus prevent the bolt 50 from being moved into its open position.

In order to release the engagement of the resilient tongues 61 in the recesses 54, a special tool with three angled hooks is required, which are introduced through narrow slots, not visible in the figures, in the cover plate 35 of the cover part 30. The special tool is also not shown in the figures. However, its configuration can be found in EP 0 616 103 B1.

In usual manner, the cover and bottom part of the container can be made of injection molded parts, in particular, from a highly transparent, stable plastic material.

Of course, the most varied departures are possible from the embodiment depicted in the figures, without thereby departing from the invented concept. Thus, the container 10 represented in FIG. 1 is somewhat rectangular in shape and relatively flat, and the bottom and cover part are each fashioned as flat shells. Of course, the container could also have an entirely different form. In particular, for example, the bottom part could be much deeper than the cover part. Apart from the fact that it makes no difference which end of the invented container is up or down, except perhaps when handling it to fill it, the locking mechanism could also be arranged in the bottom part. It is possible, with special advantage, to shorten or lengthen in simple manner the two-part bolt 50 in the described example by taking out or adding in metal parts 50a, 50b and thereby adapt it to containers of different length. Instead of the described protection by the metal band 60, other means already known in the state of the art could also be used, e.g., such as can be released simply by means of a strong magnet.

### LIST OF REFERENCE NUMBERS

10 Container

11 Compartment of the container

20 Bottom part of the container

21 Rear side wall of the bottom part

22 Front side wall of the bottom part

22a Outer front partition of the front side wall of the bottom part

22b Inner front partition of the front side wall of the bottom part

23, 24 Lateral side walls of the bottom part

25 Bottom plate of the bottom part

30 Cover part 30 of the container

31 Rear side wall of the cover part

32 Front side wall of the cover part

33, 34 Lateral side walls of the cover part

35 Cover plate of the cover part

36 Partition in the cover part

38 Retaining lug

41, 42 Links

27 Eyelets in the bottom part

37 Eyelets in the cover part

50 Bolt

50a, 50b Metal parts of the bolt

51 Activation button on the bolt

52 Tongues on the bolt

54 Recesses of the bolt

60 Metal band

61 Resilient tongues on the metal band

1. The lockable container (10) with two shell-like parts (20, 30) for protecting an object against theft, wherein the locking mechanism of the container comprises a bolt (50) which can be moved between an unlocked position and a locked position, as well as contours (27, 37, 38) in both parts, which protect the bolt from dropping out in one of the two parts (30) when the container is open and interact with the bolt in the locked position when the container is closed and prevent an opening of the container, the bolt in the locked position being protected against shifting into the open position, and this protecting (60) can only be released from the outside with the help of a special tool, characterized in that the contours in both parts comprise eyelets (27, 37), which when the container is closed are at least pairwise bearing against each other and mutually overlapping, and in which the bolt engages in the locking position.

2. Container per claim 1, characterized in that the shell-like parts (20, 30) are linked together and can fold up.

3. Container per claim 2, characterized in that the bolt (50) can move in axial direction of the link connection between both parts (20, 30) and also engages in the eyelets (27, 37) in this direction.

4. Container according to one of claims 1-3, characterized in that the bolt (50) is arranged in a compartment (51) of the container (10), which is bounded off from the rest of the container volume by at least one partition wall (36) in one of the parts (30), yet preferably by partition walls (36, 26) in both parts (20, 30) that are mutually overlapping when the container is closed.

5. Container according to one of claims 1-4, characterized in that the two shell-like parts (20, 30) each have side walls (21-24, 31-32) and the side walls (21-24) of at least one (20) of the two parts are double wall, at least for a segment, and the opposite side walls (31-34) of the other part engage between the double-wall side parts, at least in a segment, when the container is closed.

6. Container according to one of claims 1-5, characterized in that the bolt (50) comprises at least one metal part (50) made from a sheet material by stamping and/or embossing, on which at least one projecting tongue (52) is formed for engaging in the eyelets (27, 37).

7. Container per claim 6, characterized in that the bolt (50) is formed by several metal parts (50a, 50b), lined up lengthwise with each other.
